(19) United States
(12) Patent Application Publication
(10) Pub. No.: US 2001/0034744 A1
(43) Pub. Date: Oct. 25, 2001

(54) Data input form generation system, data input form generation method, and computer-readable recording medium

(75) Inventors: Susumu Honma, Minato-ku (JP); Hidetoshi Osafune, Minato-ku (JP)

Correspondence Address: OLIFF & BERRIDGE, PLC, 277 S. WASHINGTON STREET, SUITE 500, ALEXANDRIA, VA, 22314, US

(73) Assignee: FUJI XEROX CO., LTD.

(21) Appl. No.: 09/836,271

(22) Filed: Apr. 18, 2001

(30) Foreign Application Priority Data
Apr. 20, 2000 (JP) 2000-119680

(51) Int. Cl. G06F 7/00

(52) U.S. Cl. 707/509; 707/1

(57) ABSTRACT

The present invention provides a data input form generation system capable of generating a data input form which can easily used to construct a database. A data input form generation system has a data input form acceptance unit for accepting input of a data input form including a table, a table extraction unit for extracting the table from the data input form accepted by the data input form acceptance unit, a database defining unit for defining a database based on the table extracted by the table extraction unit, and a data input form generation unit for generating a database-related data input form related with the database by relating the table included in the data input form accepted by the data input form acceptance unit with the database defined by the database defining unit.

### BACKGROUND OF THE INVENTION

1. Field of the Invention

The present invention relates to a data input form generation system for generating data input forms such as business forms, a data input form generation method, and a computer-readable recording medium.

2. Description of the Prior Art

It is very important to manage information in the information society in recent years. To manage such information, processes for inputting information and constructing a database of information are essential. The information described above is usually inputted using a data input form such as a business form, and then, is constructed into a database by an information administrator. Japanese Published Unexamined Patent Application No. Hei 6-149894 discloses a database define method for defining a database based on a specific symbol described into a data input form.

However, there have been the following problems in the database define method according to the prior art. The database define method according to the prior art defines a database based on a specific symbol described into a data input form. In order to construct a database from the data input form, the specific symbol must be previously described in a suitable position in the data input form. As a result, when the data input form producer has poor knowledge about database, it is difficult to construct a suitable database.

### SUMMARY OF THE INVENTION

Accordingly, the present invention solves the foregoing problems and provides a data input form generation system, a data input form generation method, and a computer-readable recording medium which can generate a data input form which can easily construct a database of inputted information.

To solve the foregoing problems, a data input form generation system of the present invention has a data input form acceptance part for accepting input of a data input form including a table, a table extraction part for extracting the table from the data input form accepted by the data input form acceptance part, a database defining part for defining a database based on the table extracted by the table extraction part, and a data input form generation part for generating a database-related data input form related with the database by relating the table included in the data input form accepted by the data input form acceptance part with the database defined by the database defining part.

A data input form generation method of the present invention has a data-input form acceptance step for accepting input of a data input form including a table, a table extraction step for extracting the table from the data input form accepted in the data input form acceptance step, a database defining step for defining a database based on the table extracted by the table extraction step, and a data input form generation step for generating a database-related data input form related with the database by relating the table included in the data input form accepted by the data input form acceptance step with the database defined in the database defining step.

A computer-readable recording medium of the present invention records a program for a computer to execute a data input form acceptance step for accepting input of a data input form including a table, a table extraction step for extracting the table from the data input form accepted in the data input form acceptance step, a database defining step for defining a database based on the table extracted in the table extraction step, and a data input form generation step for generating a database-related data input form related with the database by relating the table included in the data input form accepted in the data input form acceptance step with the database defined in the database defining step.

In many cases, the data input form includes an explanation statement, drawing or table in consideration of the convenience for a person inputting data. Information to be managed is often included in the table part. Therefore, a table is extracted from the accepted data input form, a database is defined based on the table, and a database-related data input form related with the database is generated by relating the table with the database. The database can be defined without requiring a specific process of, for example, describing a specific symbol in the data input form.

### DESCRIPTION OF THE DRAWINGS

Preferred embodiments of the present invention will be described in detail based on the followings, wherein:

FIG. 1 is a block diagram of a data input form generation system;

FIG. 2 shows a data input form;

FIG. 3 shows a configuration of a database;

FIG. 4 shows relation between the data input form and the configuration of the database;

FIG. 5 is a flowchart showing the operation of the data input form generation system;

FIG. 6 shows the data input form which includes pieces of data;

FIG. 7 shows the database which includes field names and pieces of data;

FIG. 8 is a block diagram of a recording medium;

FIG. 9 is a block diagram of a computer system; and

FIG. 10 is perspective view of a computer.

### DESCRIPTION OF THE PREFERRED EMBODIMENT

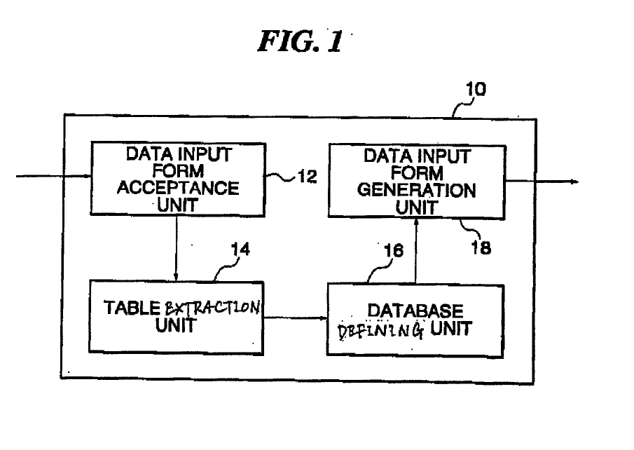

A data input form generation system according to an embodiment of the present invention will be described with reference to the drawings. First, the construction of the data input form generation system according to this embodiment will be described. FIG. 1 is a block diagram of the data input form generation system according to this embodiments

A data input form generation system 10 according to this embodiment has, as shown in PIG. 1, a data input form acceptance unit 12, a table extraction unit 14, a database defining unit 16, and a data input form generation unit 18. The respective components will be described in detail hereinbelow.

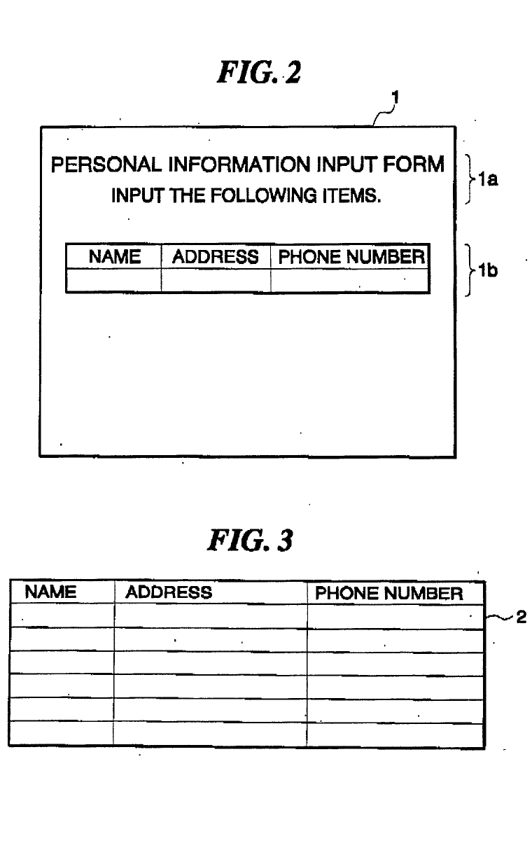

The data input form acceptance unit 12 accepts the input of a data input form. More specifically, the data input form acceptance unit 12 receives a data input form transmitted through a network and stores the data input form in a storage unit, not shown. Such a data input form is a data input form constructed as electronic document data created with a word processor, and, as shown in FIG. 2, includes a character string 1a such as a title or notes and a table 1b as a part for inputting data actually. Such data input form 1 may include a drawing as well as the character string 1a and the table 1b. The data input form constructed as the electronic document data also includes a Web page described with HTML.

The table extraction unit 14 extracts a table from the data input form accepted by the data input form acceptance unit 12. More specifically, the table extraction unit 14 analyzes layout of the data input form accepted by the data input form acceptance unit 12, and extracts a table included in the data input form. When the data input form accepted by the data input form acceptance unit 12 is the data input form 1 as shown in FIG. 2, the table extraction unit 14 extracts the table 1b from the data input form 1.

The database defining unit 16 defines a database based on the table extracted by the table extraction unit 14. More specifically, the database defining unit 16 defines a database having, as a field name, each data piece included in the first-row cell of the table extracted by the table extraction unit 14. For example, when the data input form by accepted by the data input form acceptance unit 12 is the data input form 1 as shown in FIG. 2, the table 1b included in the data input form 1 has two rows and three columns, data included in the first-row three cells of the table 1b being a “name”, “address”, and “phone number”, respectively. In this case, the database defining unit 16 has, as a field name, a “name”, “address”, or “phone number” being data included in the first-row three cells of the table 1b, and defines a database having one record including the “name”, “address”, and “phone number” (more specifically, a relational database). In other words, the database defined by the database defining unit 16 is a database 2 having the construction as shown in FIG. 3. Data pieces included in each filed of the database 2 have not been present yet.

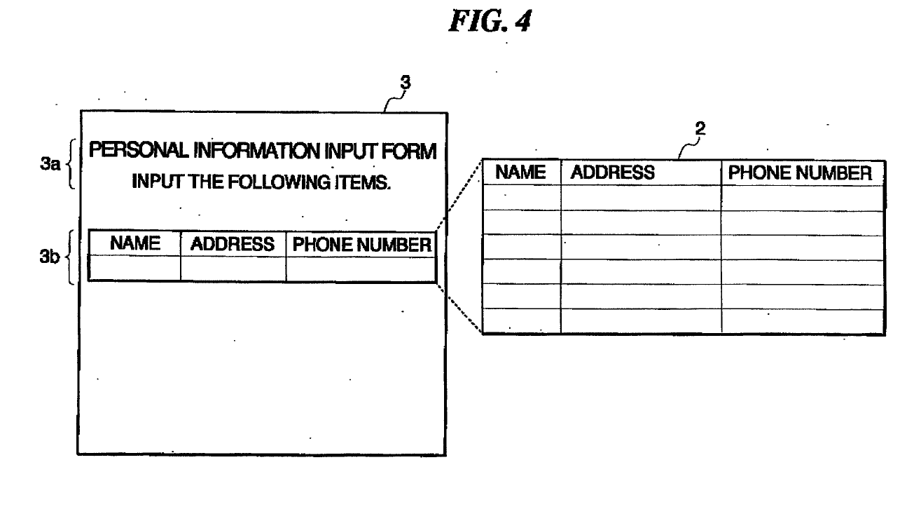

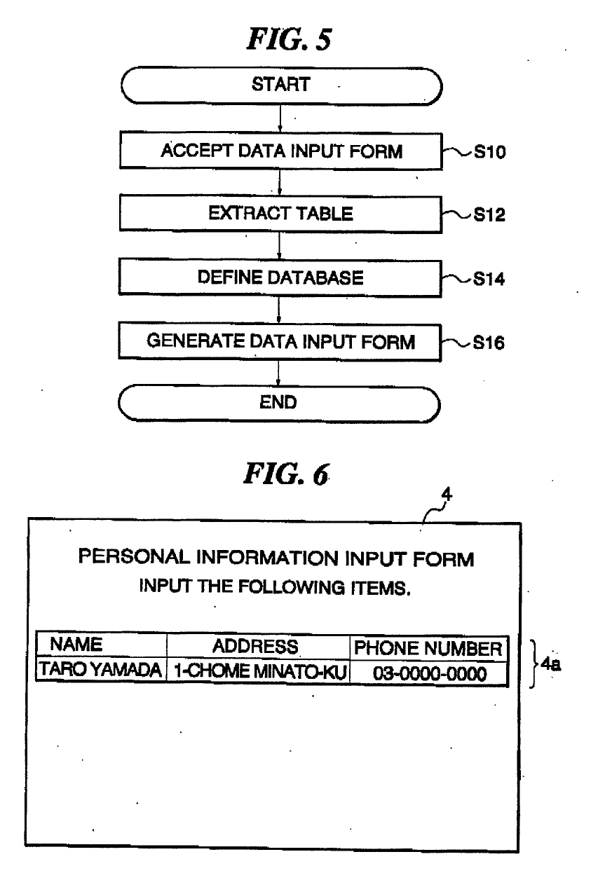

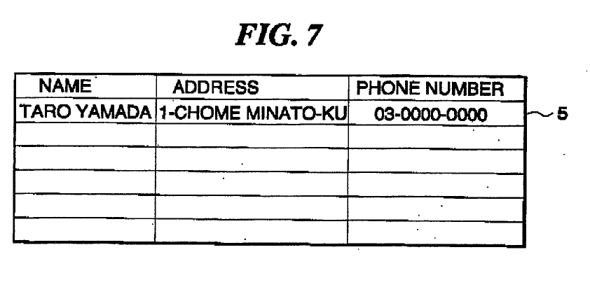

The data input form generation unit IS generates a database-related data input form related with the database by relating the table included in the data input form accepted by the data input form acceptance unit 12 with the database defined by the database defining unit 16. For example, the data input form generation unit 18 generates a database-related data input form 3 as shown in FIG. 4 when the data input form 1 as shown in FIG. 2 is accepted by the data input form acceptance unit 12. The database-related data input form 3 generated by the data input form generation unit 18 is the same in appearance (except for a difference in form such as font or margin) as compared with the data input form 1 accepted by the data input form acceptance unit 12, as shown in FIG. 4. In other words, the database-related data input form 3 generated by the data input form generation unit 18 includes a character string 3a similar to the character string 1a included in the data input form 1 accepted by the data input form acceptance unit 12, and also includes a table 3b similar to the table 1b included in the data input form 1 accepted by the data input form acceptance unit 12. However, the table 3b included in the database-related data input form 3 generated by the data input form generation unit 18 is different from the table 1b included in the data input form 1 accepted by the data input form acceptance unit 12 and is related with the database 2 defined by the database defining unit 16. When data is inputted to the table 3b included in the database-related data input form 3 generated by the data input form generation unit 18, such data is inputted to each field of the database 2 at the same time.

Subsequently, the operation of the data input form generation system according to this embodiment will be described, and together with this, the data input form generation method according to this embodiment will be described. PIG. 5 is a flowchart showing the operation of the data input form generation system according to this embodiment.

When the data input form generation system 10 according to this embodiment is used to generate the database-related data input form 3 related with the database, the input of the data input form 1 (not related with the database) is first accepted by the data input form acceptance unit 12 (S10). Such input is done in such a way that the user of the data input form generation system 10 transmits the data input form 1 to the data input form acceptance unit 12 through a network. The data input form 1 transmitted from the user of the data input form generation system 10 is received by the data input form acceptance unit 12 and stored in a storage unit, not shown. Such a data input form is a data input form constructed as electronic document data created with a word processor, and, as shown in FIG. 2, includes the character string 1a such as a title or notes and the table 1b as a part for Inputting data actually.

When the input of the data input form 1 is accepted by the data input form acceptance unit 12, the table extraction unit 14 extracts the table 1b from the data input form 1 accepted by the data input form acceptance unit 12 (S12). More specifically, the table extraction unit 14 analyzes layout of the data input form 1 accepted by the data input form acceptance unit 12, and extracts the table 1b included in the data input form 1.

When the table extraction unit 14 extracts the table 1b included in the data input form 1, the database defining unit 16 defines the database 2 based on the table 1b extracted by the table extraction unit 14 (S14). More specifically, the database defining unit 16 defines the database 2 having, as a field name, each data piece included in the first-row cell of the table extracted by the table extraction unit 14. In other words, the table 1b included in the data input form 1 accepted by the data input form acceptance unit 12 has two rows and three columns, as shown in FIG. 2. When each data piece included in the first-row three cells of the table 1b is a “name”, “address”, or “phone number”, the database defining unit 16 has, as a field name, the “name”, “address”, or “phone number” as data included in the first-row three cells of the table 1b and defines the database 2 having one record including the “name”. “address”, and “phone number” (more specifically, a relational database). The database 2 defined by the database defining unit 16 has the construction as shown in FIG. 3. Data pieces included in each filed of the database 2 have not been present yet.

When the database 2 is defined by the database defining unit 16, the data input form generation unit 18 generates the database-related data input form 3 related with the database 2 by relating the table 1b included in the data input form 1 accepted by the data input form acceptance unit 12 with the database 2 defined by the database defining unit 16. The database-related data input form 3 generated by the data input form generation unit 18 is the same in appearance (except for a difference in form such as font or margin) as compared with the data input form 1 accepted by the data input form acceptance unit 12, as shown in FIG. 4. In other words, the database-related data input form 3 generated by the data input form generation unit 18 includes the character string 3a similar to the character string 1a included in the data input form 1 accepted by the data input form acceptance unit 12, and also includes the table 3b similar to the table 1b included in the data input form 1 accepted by the data input form acceptance unit 12. However, the table 3b included in the database-related data input form 3 generated by the data input form generation unit 18 is different from the table 1b included in the data input form 1 accepted by the data input form acceptance unit 12 and is related with the database 2 defined by the database defining unit 16. The table 3b included in the database-related data input form 3 is related with the database 2 by a table, not shown, recording, for example, the response of a cell of the table 3b to the field of the database 2 corresponding with the cell. The relation can also be done by setting the field information corresponding with the database 2 as an attribute of the cell of the table 3b. When data is inputted to the table 3b included in the database-related data input form 3 generated by the data input form generation unit 18, such data is inputted to each field of the database 2 at the same time.

The operation and effect of the data input form generation system according to this embodiment will be described. In many cases, the data input form includes an explanation statement, a drawing or a table in consideration of the convenience for a person inputting data. Information to be managed is often inputted to the table part. In the data input form generation system 10 according to this embodiment, the table extraction unit 14 extracts the table 1b from the data input form 1 accepted by the data input form acceptance unit 12, the database defining unit 16 defines the database 2 based on the-table 1b, and the data input form generation unit 18 generates the database-related data input form 3 related with the database 2 by relating the table 1b and the database 2. The database 2 can be defined without requiring a specific process for describing a specific symbol into the data input form. As a result, it is possible to generate the database-related data input form 3 which can easily form a database of the inputted information.

The item name of information to be managed in the database, that is, the field name of the database is often described into the first-row cell of the table included in the data input form. The data input form generation system 10 according to this embodiment has, as the field name of the database 2, data included in the first-row cell of the table 1b included in the data input form 1 accepted by the data input form acceptance unit 12, thereby easily defining the field name of the database 2. As a result, it is very easy to form a database of the inputted information.

In the data input form generation system 10 according to this embodiment, the data input form acceptance unit 12 accepts the input of the data input form 1 constructed as electronic document data. The database-related data input form 3 related with the database 2 can be easily generated from the electronic document data created with a word processor widely used. As a result, the convenience of the data input form generation system 10 can be improved.

In the data input form generation system 10 according to the embodiment described above, data included in the first-row cell of the table 1b included in the data input form 1 accepted by the data input form acceptance unit 12 is the field name of the database 2. Data included in the first-column cell of the table included in the data input form accepted by the data input form acceptance unit 12 may be the field name of the database. The item name of information to be managed in the database, that is, the field name of the database is often described into the first-column cell of the table included in the data input form. Data included in the first-column cell of the table is the field name of the database so as to easily define the field name of the database. As a result, it is very easy to form a database of the inputted information.

In the data input from generation system 10 according to the embodiment described above, the data input form acceptance unit 12 accepts the input of the data input form 1 constructed as electronic document data, but may also accept the input of a data input form recorded onto recording paper. The input of the data input form recorded onto recording paper is accepted so as to easily generate the database-related data input form 3 related with the database from a data input form created and printed out with a word processor or a data input form written by hand. As a result, the convenience of the data input form generation system can be improved. In this case,it is preferred to read the data input form recorded onto recording paper with a scanner and to convert the read data input form to electronic document data once. The read date input form is converted to electronic document data once to subsequently perform the same processing as that explained in the embodiment described above.

The data input form generation system 10 according to the embodiment described above extracts the table 1b including data only in the first-row cell, as shown in FIG. 2, and defines the database 2 having, as a field name, each data piece included In the first-row cell, as shown in FIG. 3. This may be the following. The data input form generation system 10 may extract a table 4a including data not only in the first-row cell but also in other row cells, as shown in FIG. 6, and define a database 5 having, as a field name, each data piece included in the first-row cell of the table 4a (“name”, “address”, and “phone number”), as shown in PIG. 7. Then, data included in the second-row cell of the table 4a (including a third row or the like when there is the third row or the like) (“Taro Yamada”, “1-Chome Minato-ku”, and “03-0000-0000”) may be inserted into the database 5 as each data piece of the field. Definition of the filed name and insertion of the data make it very easy to form a database of the inputted information.

Finally, there will be described a computer-readable recording medium (hereinafter simply referred to as a recording medium) according to the embodiment of the present invention. Herein, the recording medium causes the change state of magnetic, optical, or electric energy in accordance with the described contents of the program, in a reader provided in the hardware resource of a computer, so as to transmit the described contents of the program to the reader in a form of a signal responded thereto. Such a recording medium corresponds to, for example, a magnetic disk, an optical disk, a CD-ROM, and a memory incorporated in a computer.

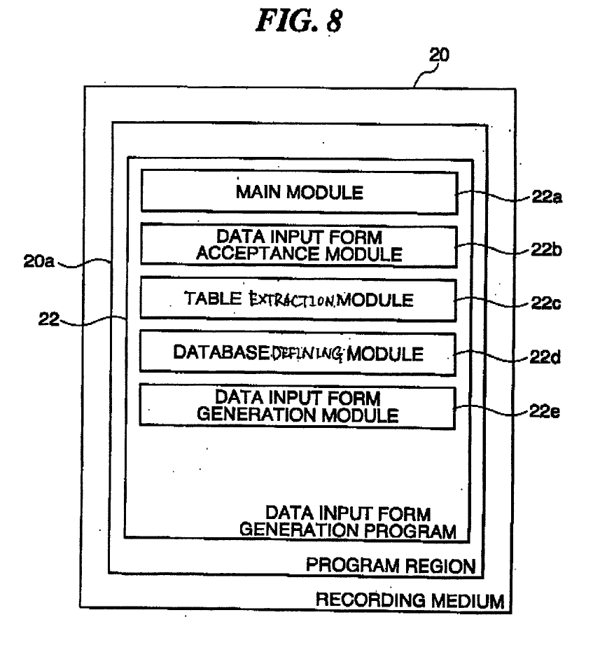

FIG. 8 is a block diagram of the recording medium according to the embodiment of the present invention. As shown in FIG. 8, a recording medium 20 is provided with a program region 20a for recording a program, this program region 20a recording a data input form generation program 22. The data input form generation program 22 has a main module 22a for controlling processes, a data input form acceptance module 22b for accepting the input of the data input form 1 including the table 1b, a table extract module 22c for extracting the table 1b from the data input form 1 accepted by operating the data input form acceptance module 22a, a database define module 22d for defining the database. 2 based on the table 1b extracted by operating the table extract module 22c, and a data input form generation module 22e for generating the database-related data input form 3 related with the database 2 by relating the table 1b included in the data input form 1 accepted by operating the data input form acceptance module 22b with the database 2 defined by operating the database define module 22d. The respective functions realized by operating the data input form acceptance module 22b, the table extract module 22c, the database define module 22d, and the data input form generation module 22e, respectively, are similar to the respective functions of the data input form acceptance unit 12, the table extraction unit 14, the database defining unit 16, and the data input form generation unit 18 of the data input form generation system 10.

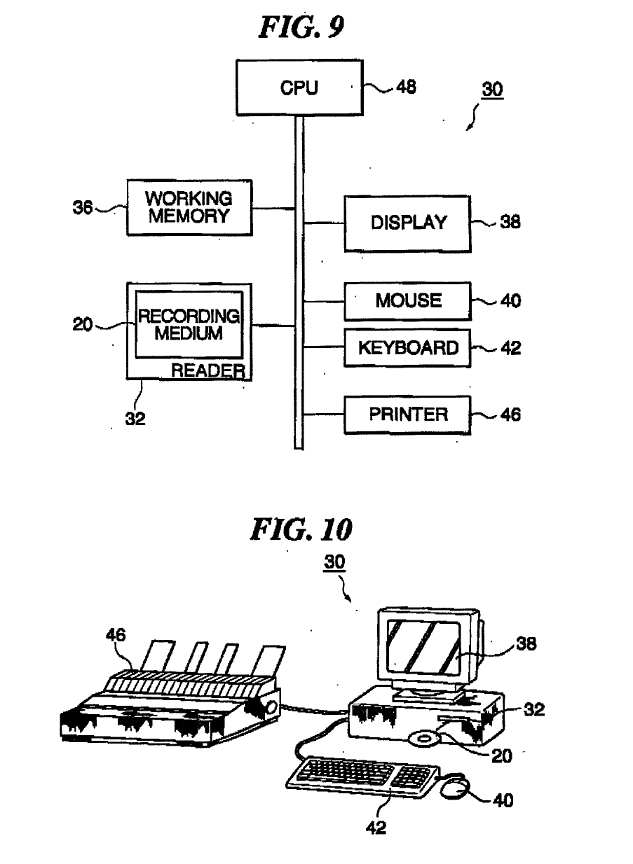

FIG. 9 is a block diagram of a computer system for executing the data input form generation program 22 recorded onto the recording medium 20. FIG. 10 is a perspective view of a computer for executing the data input form generation program 22 recorded onto the recording medium 20. As shown in FIGS. 9 and 10, a computer 30 is provided with a reader 32, an operating system (OS)-resident working memory (RAM) 36, a display 38 as a display part, a mouse 40 and a keyboard 42 as an input part, a printer 46 for providing-printout of a data input form, and a CPU 48 for controlling execution of the data input form generation program 22. When the recording medium 20 is inserted into the reader 32, information recorded onto the recording medium 20 can be accessed from the reader 32. The data input form generation program 22 recorded onto the program region 20a of the recording medium 20 can be executed by the computer 30.

A flexible disk drive, a CD-ROM drive, or a magnetic tape drive is used as the reader 32, in response to the recording medium 20.

The data input form generation system, the data input form generation method, and the computer-readable recording medium according to the present invention extract a table from the data input form accepted, define a database based on the table, and generate the database-related data input form related with the database by relating the table with the database. The database can be defined without requiring a specific process for describing a specific symbol into the data input form. As a result, it is possible to generate the data input form which can easily form a database of the inputted information.

The data input form generation system, the data input form generation method, and the computer-readable recording medium according to the present invention have, as the field name of the database, data included in the first-row cell of the table. It is possible to easily define the field name of the database. As a result, it is very easy to form a database of the inputted information.

The data input form generation system, the data input form generation method, and the computer-readable recording medium according to the present invention have, as the field name of the database, data included in the first-column cell of the table. It is possible to easily define the field name of the database. As a result, it is very easy to form a database of the inputted information.

The data input form generation system, the data Input form generation method, and the computer-readable recording medium according to the present invention accept the input of the data input form constructed as electronic document data. The database-related data input form related with the database can be easily generated from the electronic document data created with a word processor widely used. As a result, the convenience of the data input form generation system can be improved.

The data input form generation system, the data input form generation method, and the computer-readable recording medium according to the present invention accept the input of the data input form recorded onto recording paper. The database-related data input form related with the database can be easily generated from a data input form created and printed out with a word processor or a data input form written by hand. As a result, the convenience of the data input form generation system can be improved.

The entire disclosure of Japanese Patent Application No. 2000-119680 filed on Apr. 20, 2000 including specification, claims, drawings and abstract is incorporated herein by reference in its entirety.

What is claimed is:

1. A data input form generation system comprising:
data input form acceptance means for accepting input of a data input form including a table;
table extraction means for extracting the table from the data input form accepted by the data input form acceptance means;
database defining means for defining a database based on the table extracted by the table extraction means; and
data input form generation means for generating a database-related data input form related with the database by relating the table included in the data input form accepted by the data input form acceptance means with the database defined by the database defining means.

2. The data input form generation system according to claim 1, wherein the database defining means has, as a field name of the database, data included in a first-row cell of the table extracted by the table extraction means.

3. The data input form generation system according to claim 1, wherein the database defining moans has, as a field name of the database, data included in a first-column cell of the table extracted by the table extraction means.

4. The data input form generation system according to claim 1, wherein the data input form acceptance means accepts input of the data input form configured as electronic document data.

5. The data input form generation system according to claim 1, wherein the data input form acceptance means accepts input of the data input form recorded onto a recording sheet.

6. A data input form generation method comprising:
accepting input of a data input form including a table;
extracting the table from the accepted data input form,
defining a database based on the extracted table; and
generating a database-related data input form related with the database by relating the table included in the accepted data input form with the defined database.

7. The data input form generation method according to claim 6, wherein data included in a first-row cell of the extracted table is held as a field name of the database.

8. The data input form generation method according to claim 6, wherein data included in a first-column cell of the extracted table is held as a field name of the database.

9. The data input form generation method according to claim 6, wherein input of the data input form configured as electronic document data is accepted.

10. The data input form generation method according to claim 6, wherein input of the data input form recorded onto a recording sheet is accepted.

11. A computer-readable recording medium recording thereon a program that makes a computer execute the steps of:
accepting input of a data input form including a table;
extracting the table from the accepted data input form;
defining a database based on the extracted table; and
generating a database-related data input form related with the database by relating the table included in the accepted data input form with the defined database.

12. The computer-readable recording medium according to claim 11, wherein data included in a first-row cell of the extracted table is held as a field name of the database.

13. The computer-readable recording medium according to claim 11, wherein data included in a first-column cell of the extracted table as a field name of the database.

14. The computer-readable recording medium according to claim 11, wherein input of the data input form configured as electronic document data is accepted.

15. The computer-readable recording medium according to claim 11, wherein input of the data input form recorded onto a recording sheet is accepted.
